(19) United States
(12) Patent Application Publication
(10) Pub. No.: US 2008/0068248 A1
(43) Pub. Date: Mar. 20, 2008

(54) Remote controller

(76) Inventor: Akio Iwai, Osaka (JP)

Correspondence Address: MORGAN LEWIS & BOCKIUS LLP, 1111 PENNSYLVANIA AVENUE NW, WASHINGTON, DC, 20004, US

(21) Appl. No.: 11/902,058

(22) Filed: Sep. 18, 2007

(30) Foreign Application Priority Data
Sep. 19, 2006 (JP) 2006-252204

(51) Int. Cl. G08C 19/12; H04N 5/44

(52) U.S. Cl. 341/176; 348/734

(57) ABSTRACT

A remote controller, which enables secure pressing operation of operational buttons, includes a top case (10) having a plurality of through holes (12) and a plurality of operational buttons (31) exposed respectively from the through holes of the top case, so that each of the operational buttons is pressed for controlling equipment. Ribs (13) protrude from the inner surface of the top case along circumferences of the through holes.

This application is based on Japanese Patent Application No. 2006-252204 filed on Sep. 19, 2006, the contents of which are hereby incorporated by reference.

### BACKGROUND OF THE INVENTION

1. Field of the Invention

The present invention relates to a remote controller for remote control of various types of equipment.

2. Description of Related Art

There are various types of equipment that can be controlled by using a remote controller. In particular, general electric equipment that can be controlled by a remote controller includes a television set that receives broadcasting programs and displays them, a moving image recording and reproducing device that records moving image information (including sound information) such as a broadcasting program or the like on a recording medium and reads the recording information so that the moving image can be reproduced like an HDD (Hard Disk Drive) recorder, a DVD (Digital Versatile Disk) recorder or a video tape recorder, an audio visual device such as a stereo set that reproduces music and sounds, an air conditioner and the like. Control of the electric equipment by using the remote controller is performed when a user presses a desired operational button on the remote controller and then an instruction signal assigned to the operational button is transmitted from the remote controller.

As shown in FIGS. 5 and 6, a conventional ordinary remote controller has a casing made up of a top case 110 and a bottom case 120, in which an operational button body 130, a circuit board 140, a transmitter (not shown), a battery (not shown) and the like are disposed (see JP-A-H5-205559 and JP-A-2006-19880, for example). The circuit board 140 is supported in the state sandwiched between a lower column 121 protruding from the inner surface of the bottom case 120 and an upper column (not shown) protruding from the inner surface of the top case 110. The bottom case 120 and the top case 110 are fastened to each other with screws.

In addition, the operational button body 130 is made of an elastic material such as silicone rubber. It has integrally a plurality of operational buttons 131 arranged with a predetermined space and a base portion 132 disposed among the operational buttons 131 and connected to neighboring operational buttons 131. This operational button body 130 is supported in the state where its base portion 132 is put on the circuit board 140 and pushed by a grid-like rib 111 protruding from the inner face of the top case 110 (see FIG. 6) onto the circuit board 140.

The top case 110 is provided with through holes 112 formed at positions corresponding to the operational buttons 131, and the operational buttons 131 are exposed from the through holes 112. Each of the operational buttons 131 is floated from the circuit board 140 slightly, and switch contacts are disposed on the circuit board 140 directly below the operational buttons 131.

According to this structure, when the operational button 131 is pressed by a light force, a connection portion between the operational button 131 and the base portion 132 is deformed elastically as it is, and the operational button 131 contacts with the circuit board 140 so that the switch contact disposed there is made. In this case, if the operational button 131 is pressed by a strong force right down, the operational button 131 itself is further deformed elastically to compress as shown in FIG. 7. When the switch contact is made, an infrared signal of an instruction assigned to the switch contact is transmitted from the transmitter, so that the signal controls the target electric equipment. When the press operation of the operational button 131 is cancelled, the operational button 131 returns to its original position by its elastic restoring force (see FIG. 5), so that the switch contact is broken.

Although pressing operation by a light force or a strong force right down is expected naturally as the operation of the operational button 131, some users may press it by a strong force in a slanting direction. In this case, a state of so-called button stuck may occur in the above mentioned conventional remote controller as shown in FIG. 8, in which the operational button 131 pressed by a strong force in a slanting direction enters lower than the through hole 112 so that a corner of its upper surface enters along the inner surface of the top case 110 locally. Even if the pressing operation is cancelled in this state, the corner of the upper surface of the pressed bottom is caught by the inner surface of the top case 110 so that the pressed state of the bottom remains. If such a button stuck state occurs, not only the stuck operational button 131 but also other operational buttons 131 cannot be operated because the switch contact of the stuck operational button remains in the connected state.

### SUMMARY OF THE INVENTION

The present invention is made in view of the above described problem and it is an object of the present invention to provide a remote controller in which pressing operation of its operational button can be performed securely.

To attain the above described object, a remote controller according to a first aspect of the present invention includes a top case having a plurality of through holes, and a plurality of operational buttons exposed respectively from the through holes of the top case, so that each of the operational buttons is pressed for controlling the equipment, the remote controller is characterized by a structure in which ribs protrude from the inner surface of the top case along circumferences of the through holes.

According to this structure, even if the operational button is pressed by a strong force in a slanting direction, the inner surface of the rib that extends from the through hole prevents the button from disengagement. Therefore, it can be avoided that a corner of the upper surface of the operational button enters along the inner surface of the top case. As a result, when pressing operation is canceled, button stuck does not occur.

As to a remote controller according to a second aspect of the present invention, the equipment is a television set that receives and displays a broadcasting program in the remote controller of the above mentioned first aspect.

A remote controller according to a third aspect of the present invention that is for remote control of a television set that receives and displays a broadcasting program, includes a top case having a plurality of through holes, and a plurality of operational buttons exposed respectively from the through holes of the top case, so that each of the operational buttons is pressed for controlling the television set, and the remote controller is characterized by a structure in which ribs protrude from the inner surface of the top case along circumferences of the through holes.

According to this structure, even if the operational button is pressed by a strong force in a slanting direction, the inner surface of the rib that extends from the through hole prevents the button from disengagement. Therefore, it can be avoided that a corner of the upper surface of the operational button enters along the inner surface of the top case. As a result, when pressing operation is canceled, button stuck does not occur.

According to the present invention, it is possible to provide a remote controller that can prevent button stuck so that pressing operation of operational buttons can be performed securely.

### BRIEF DESCRIPTION OF THE DRAWINGS

FIG. 1 is a cross sectional view to show a main portion of a remote controller according to an embodiment of the present invention.

FIG. 2 is a perspective view of a top case of the remote controller shown in FIG. 1 viewed from the inside.

FIG. 3 is a cross sectional view to show an example of an operating state of the remote controller shown in FIG. 1.

FIG. 4 is a cross sectional view to show an example of an operating state of the remote controller shown in FIG. 1.

FIG. 5 is a cross sectional view to show a main portion of a conventional remote controller.

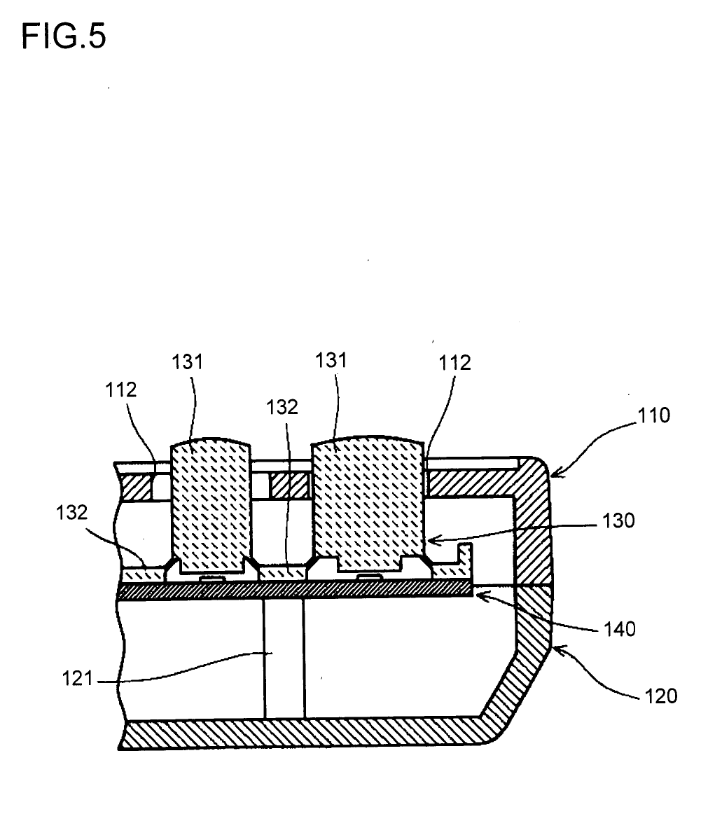

FIG. 6 is a perspective view of a top case of the remote controller shown in FIG. 5 viewed from the inside.

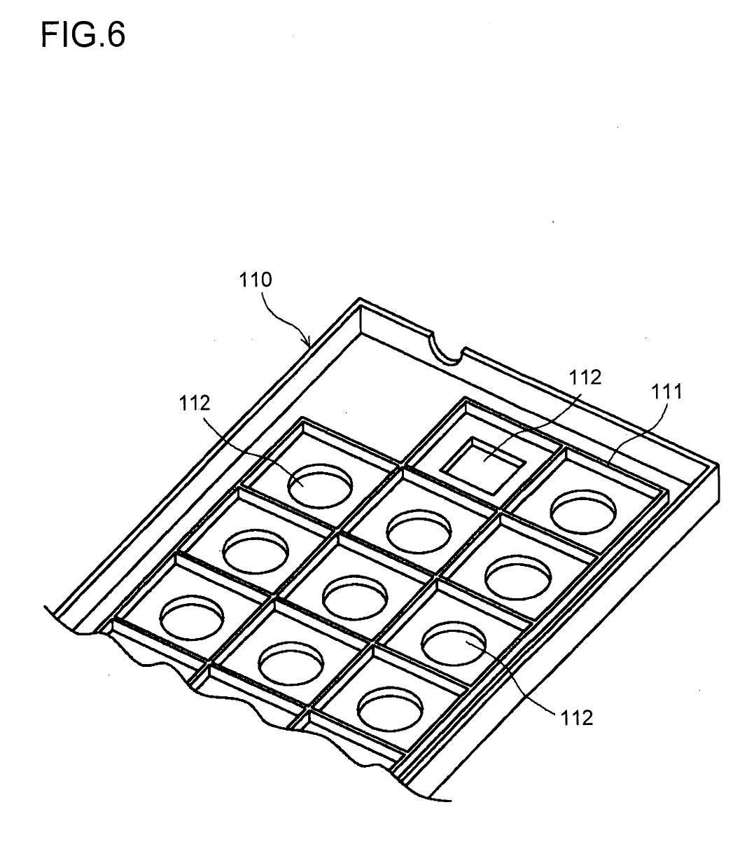

FIG. 7 is a cross sectional view to show an example of an operating state of the remote controller shown in FIG. 5.

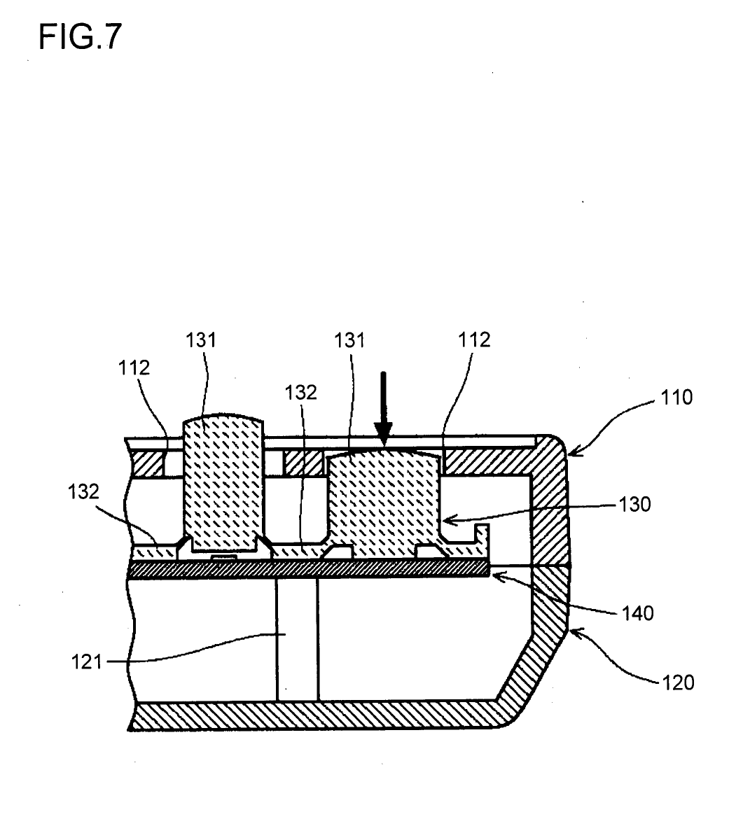

FIG. 8 is a cross sectional view to show an example of an operating state of the remote controller shown in FIG. 5.

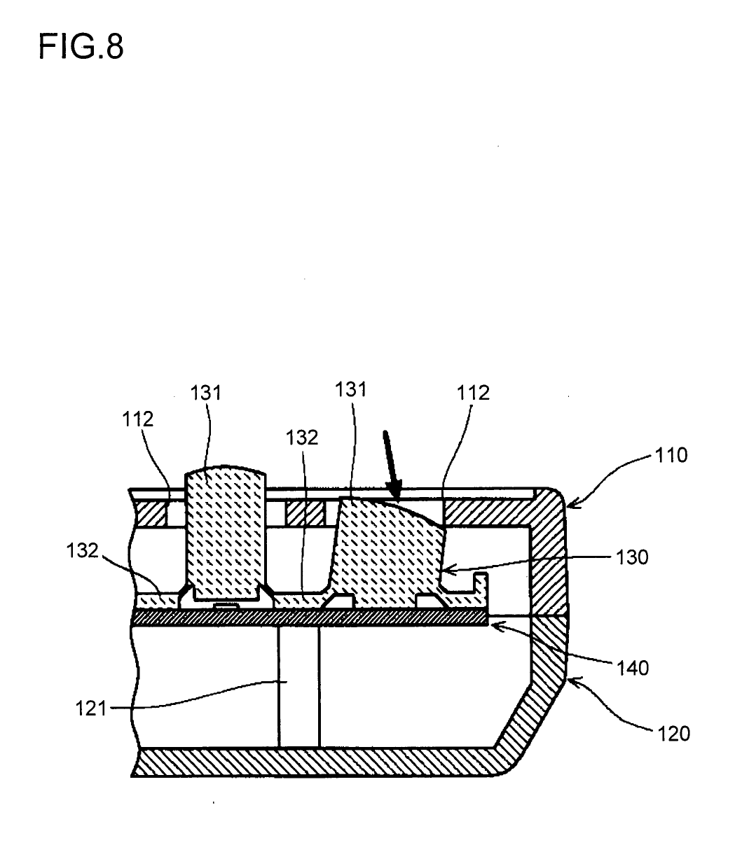

### DETAILED DESCRIPTION OF THE PREFERRED EMBODIMENTS

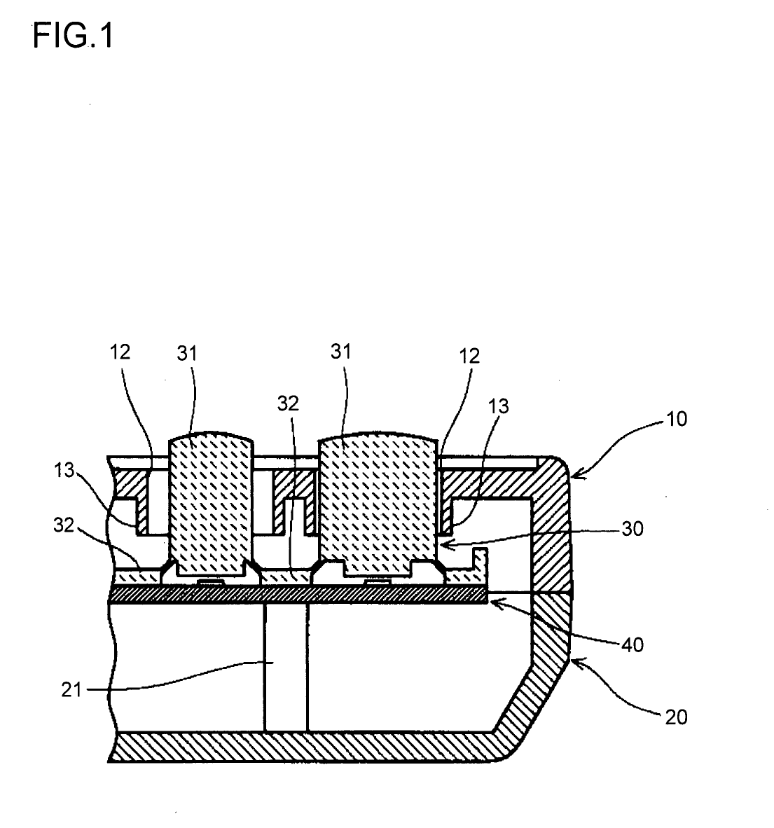

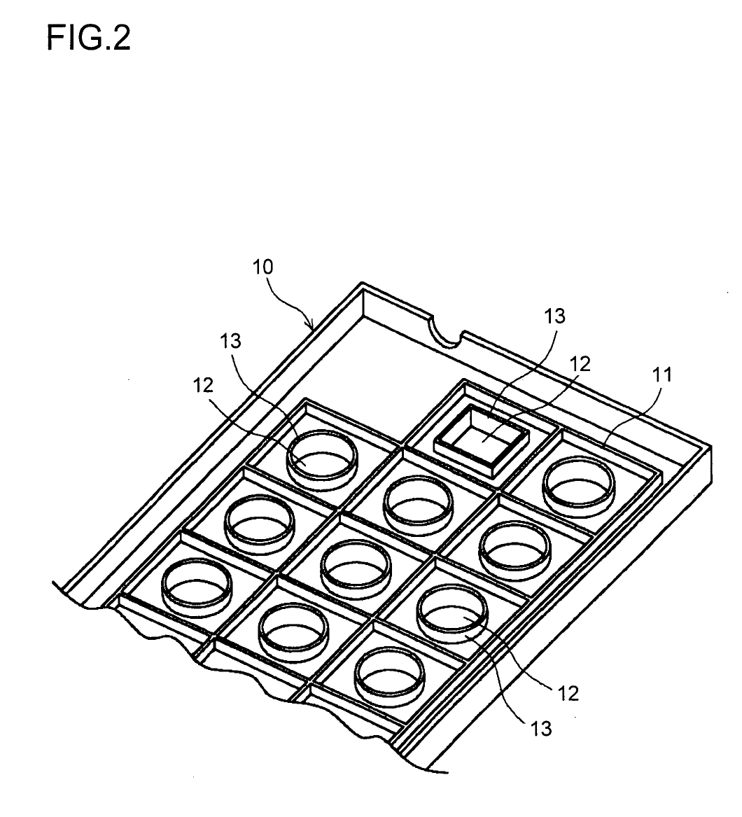

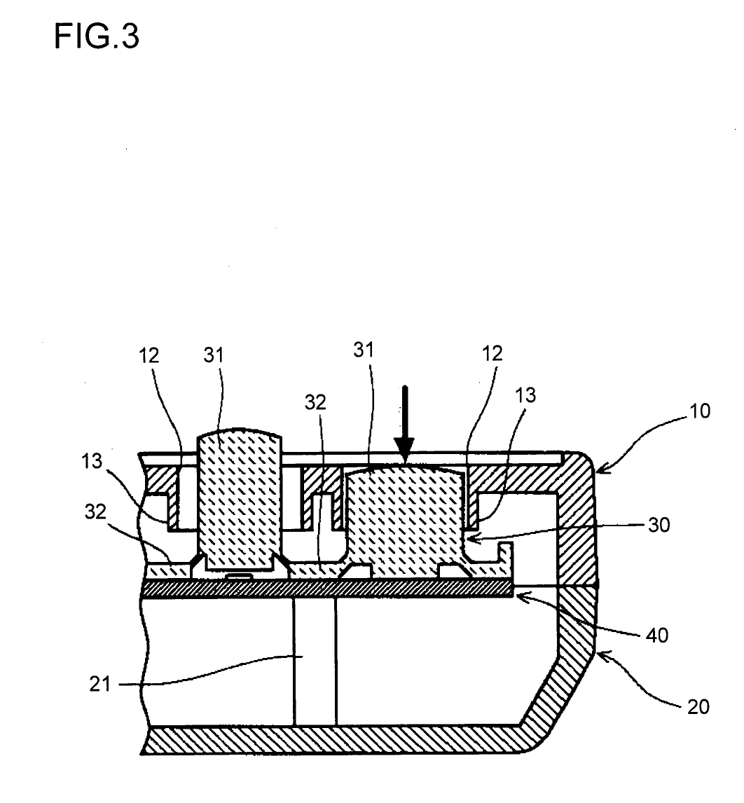

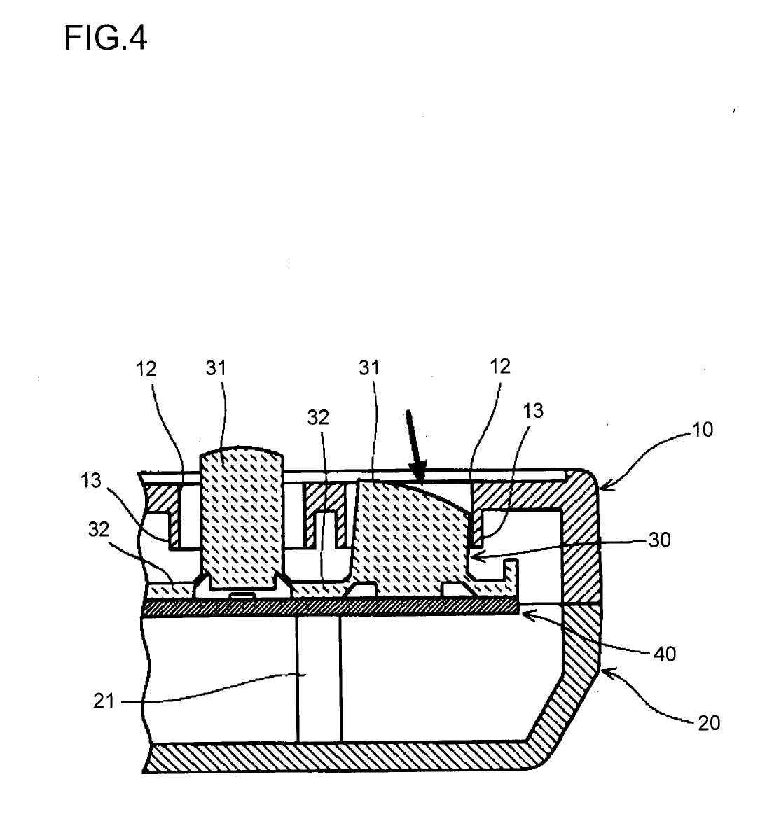

Hereinafter, an embodiment of a remote controller according to the present invention will be described in detail with reference to the attached drawings. FIG. 1 is a cross sectional view to show a main portion of an remote controller according to an embodiment of the present invention, FIG. 2 is a perspective view of a top case of the remote controller viewed from the inside, and FIG. 3 and FIG. 4 are cross sectional views to show an example of an operating state of the remote controller. FIG. 3 shows the state where an operational button is pressed by a strong force right down, while FIG. 4 shows the state where the operational button is pressed by a strong force in a slanting direction.

The remote controller of this embodiment is used for controlling a television set as an example of electric equipment. The television set has an essential function to receive moving image information (including sound information) of a broadcasting program of each channel and displaying the moving image for a user to watch.

As shown in FIG. 1 and FIG. 2, the remote controller has a casing made up of a top case 10 and a bottom case 20, in which an operational button body 30, a circuit board 40, a transmitter (not shown), a battery (not shown) and the like are disposed. The top case 10 and the bottom case 20 of this embodiment are molded of a synthetic resin such as polystylene or acrylonitrile-butadiene copolymer. The circuit board 40 is supported in the state sandwiched between a lower column 21 protruding from the inner surface of the bottom case 20 and an upper column (not shown) protruding from the inner surface of the top case 10. The bottom case 20 and the top case 10 are fastened to each other with screws.

In addition, the operational button body 30 is made of an elastic material such as silicone rubber. It has integrally a plurality of operational buttons 31 arranged with a predetermined space and a base portion 32 disposed among the operational buttons 31 and connected to neighboring operational buttons 31. The operational button 31 has a cylindrical shape or a square pole shape. This operational button body 30 is supported in the state where its base portion 32 is put on the circuit board 40 and pushed by a grid-like rib 11 protruding from the inner face of the top case 10 (see FIG. 2) onto the circuit board 40.

The top case 10 is provided with through holes 12 formed at positions corresponding to the operational buttons 31 to have shapes corresponding to the operational buttons 31, and the operational buttons 31 are exposed from the through holes 12. Each of the operational buttons 31 is floated from the circuit board 40 slightly, and switch contacts are disposed on the circuit board 40 directly below the operational buttons 31. The switch contacts corresponding to operational buttons 31 are assigned to power on/off of the television set, channel numbers, channel up, channel down, volume up, volume down, input selection and the like, individually. A microcomputer that controls entire operation of the remote controller, a memory and the like are mounted on the circuit board 40.

In this embodiment of the present invention, a rib 13 protrudes from the inner surface of the top case 10 along circumference of each of the through holes 12. Therefore, each of the operational buttons 31 is surrounded by the inner surface of the through hole 12 as well as the inner surface of the rib 13.

When the operational button 31 is pressed by a light force in this structure, a connection portion between the operational button 31 and base portion 32 is deformed elastically as it is, and the operational button 31 contacts with the circuit board 40 so that the switch contact disposed there is made. In this case, if the operational button 31 is pressed by a strong force right down, the operational button 31 itself is further deformed elastically to compress as shown in FIG. 3. When the switch contact is made, an infrared signal of an instruction assigned to the switch contact is transmitted from the transmitter, so that the signal controls the target electric equipment. When the press operation of the operational button 31 is cancelled, the operational button 31 returns to its original position by its elastic restoring force (see FIG. 1), so that the switch contact is broken.

In addition, if the operational button 31 is pressed by a strong force in a slanting direction, the operational button 31 contacts with the circuit board 40 to make the switch contact, and in addition, the operational button 31 itself is deformed elastically to compress and a corner of the upper surface of the operational button 31 enters inward from the through hole 12 locally as shown in FIG. 4. However, since there is the rib 13 continuing the through hole 12, the operational button 31 abuts the inner surface of the rib 13 and does not enter along the inner surface of the top case 10. Therefore, if the pressing operation is cancelled in this state, a button stuck state does not occur, and the operational button 31 returns to its original position so that the switch contact is broken. In this way, according to the remote controller of the present invention, the button stuck can be prevented, so that pressing operation of the operational button 31 can be performed securely. In addition, since the elastic deformation of the operational button 31 itself is restricted by abutting with the inner surface of the rib 13, deformation quantity of the operational button 31 is controlled virtually to be small. As a result, improvement of life of the operational button 31 can be expected.

Note that the protruding height of the rib 13 from the inner surface of the top case 10 is the extent that the upper surface of the operational button 31 does not become lower than the lower edge of the rib 13 even if the operational button 31 is pressed by a strong force in a slanting direction.

The present invention is not limited to the embodiment described above, which can be modified variously in the scope of the present invention without deviating from the spirit thereof. For example, the electric equipment as a target of remote control is not limited to the television set but can be a moving image recording and reproducing device such as an HDD recorder, DVD recorder or a video tape recorder. The present invention can also be applied to other audio visual device such as a stereo set. In addition, the present invention can be applied generally to any equipment that can be controlled by a remote controller without limiting to electric equipment.

The present invention is useful to a remote controller for remote control of various types of equipment.

What is claimed is:

1. A remote controller for remote control of equipment, comprising:
a top case having a plurality of through holes; and
a plurality of operational buttons exposed respectively from the through holes of the top case, so that each of the operational buttons is pressed for controlling the equipment, wherein
ribs protrude from the inner surface of the top case along circumferences of the through holes.

2. The remote controller according to claim 1, wherein the equipment is a television set that receives and displays a broadcasting program.

3. A remote controller for remote control of a television set that receives and displays a broadcasting program, comprising:
a top case having a plurality of through holes; and
a plurality of operational buttons exposed respectively from the through holes of the top case, so that each of the operational buttons is pressed for controlling the television set, wherein
ribs protrude from the inner surface of the top case along circumferences of the through holes.
